(19) United States
(12) Patent Application Publication
(10) Pub. No.: US 2026/0054789 A1
(43) Pub. Date: Feb. 26, 2026

(54) TRAILER FOR MATERIAL TRANSPORT

(71) Applicant: Garlock Equipment Company, Plymouth, MN (US)

(72) Inventors: Trevor W. Maier, Brainerd, MN (US); Jacob Ronald Thieschafer, Coon Rapids, MN (US)

(21) Appl. No.: 19/298,894

(22) Filed: Aug. 13, 2025

Related U.S. Application Data
(60) Provisional application No. 63/686,381, filed on Aug. 23, 2024.

(51) Int. Cl. B62D 63/06

(52) U.S. Cl. CPC B62D 63/061

(57) ABSTRACT

A trailer for carrying and transporting a load includes a frame, a steering assembly, transport wheels, and a trailer extension with a pair of swivel wheels. The steering assembly is adjacent to the frame’s leading end and pivotable about at least one steering axis perpendicular to the longitudinal axis. Transport wheels are located on opposite lateral sides of the frame and movably support the frame, and at least one set of transport wheels are steerable via the steering axis. The trailer extension is mounted on the frame. The pair of swivel wheels are located on opposite lateral sides of the trailer extension and are freely rotatable about a rotation axis, enhancing the turn radius of the trailer.

### CROSS-REFERENCE TO RELATED APPLICATIONS

The present disclosure claims priority to Provisional Application No. 63/686,381, filed August 23, 2024, entitled "TRAILER FOR MATERIAL TRANSPORT", the contents of which are hereby incorporated by reference herein in their entirety.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Trailers for transporting materials are used by placing materials on a trailer bed or frame and hauling such materials. Trailers typically have a maximum carrying capacity, wherein a trailer is limited by its ability to carry a maximum amount of weight as its load, beyond which the trailer fails to operate as intended. Trailers also typically have a maneuverability limitation, wherein the trailer is restricted in its turn radius or may be unable to make turns altogether. Thus, trailers with improved carrying capacity along with improved maneuverability are desirable.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In at least one embodiment, a trailer extension for a trailer frame includes a trailer extension body having a first end and a second end. The trailer extension body comprises a first support rail extending longitudinally from the first end to the second end and the first support rail being attachable to the trailer frame. The trailer extension body further comprises a second support rail extending longitudinally from the first end to the second end, the second support rail being attachable to the trailer frame and the second support rail being parallel to the first support rail. The trailer extension body further comprises at least a first slat secured to the first support rail and the second support rail. The first slat spans between the first support rail and the second support rail. The trailer extension for the trailer frame further includes a pair of swivel wheels comprising a first swivel wheel and a second swivel wheel. The pair of swivel wheels are mounted on the trailer extension body, and the pair of swivel wheels are freely rotatable about a first axis.

In some embodiments, a trailer comprises a frame, a steering assembly, a first pair of transport wheels, and a pair of swivel wheels. The frame includes a leading end and a trailing end spaced from the leading end along a longitudinal axis. The frame includes a frame body comprising one or more frame members for supporting a load and one or more wheel axles. The frame further includes a first rail extending longitudinally from the leading end to the trailing end. The first rail is coupled to the frame body. The frame further includes a second rail laterally spaced from the first rail. The second rail extends longitudinally from the leading end to the trailing end and the second rail is coupled to the frame body. The steering assembly extends from the leading end and pivotable about at least one steering axis perpendicular to the longitudinal axis. The first pair of transport wheels are located on opposite sides of the frame and connected to one of the one or more wheel axles of the frame body. The first set of transport wheels are steerable, via the steering assembly, about the steering axis, and the first pair of transport wheels are movably supporting the frame. The pair of swivel wheels are located on opposite sides of the frame, the pair of swivel wheels are freely rotatable about a swivel axis perpendicular to the longitudinal axis of the frame.

In some embodiments, a trailer comprises a frame, a steering assembly, a first pair of transport wheels, a trailer extension, and a pair of swivel wheels. The frame has a frame leading end and a frame trailing end spaced from the frame leading end along a longitudinal axis. The steering assembly is adjacent to the frame leading end and pivotable about at least one steering axis perpendicular to the longitudinal axis. The first pair of transport wheel are located on opposite lateral sides of the frame. The first set of transport wheels are steerable via the steering assemblyand the first pair of transport wheels are movably supporting the frame. The trailer extension is mounted on a top side of the frame. The trailer extension has a trailer extension leading end and a trailer extension trailing end spaced from the trailer extension leading end along the longitudinal axis. The pair of swivel wheels are located on opposite lateral sides of the trailer extension proximate the trailer extension trailing end. The pair of swivel wheel are freely rotatable about a swivel axis perpendicular to the longitudinal axis.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a perspective view of a trailer assembly, in accordance with at least one embodiment of the present disclosure.

FIG. 2 is a perspective view of a steering assembly of the trailer assembly of FIG. 1.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, and/or components have not been described in detail so as not to obscure the discussion.

The present disclosure describes a novel and advantageous trailer assembly for hauling materials, such as roofing materials, general construction materials, or any other types of materials for which the described configuration would be useful. The trailer assembly includes a frame, a steering assembly, transport wheels, a frame extension, and pivot wheels. In some embodiments, the frame extension is integrated with the frame and thus the frame and the frame extension constitute a singular integrated part. The addition of the frame extension along with the swivel wheels to the trailer allow for the trailer assembly to increase its carrying capacity. Further, the swivel wheels allow for a tight turn radius of the trailer assembly where desired. In some embodiments, the trailer extension and/or the swivel wheels are removable and hence provide a degree of customizability to the trailer assembly.

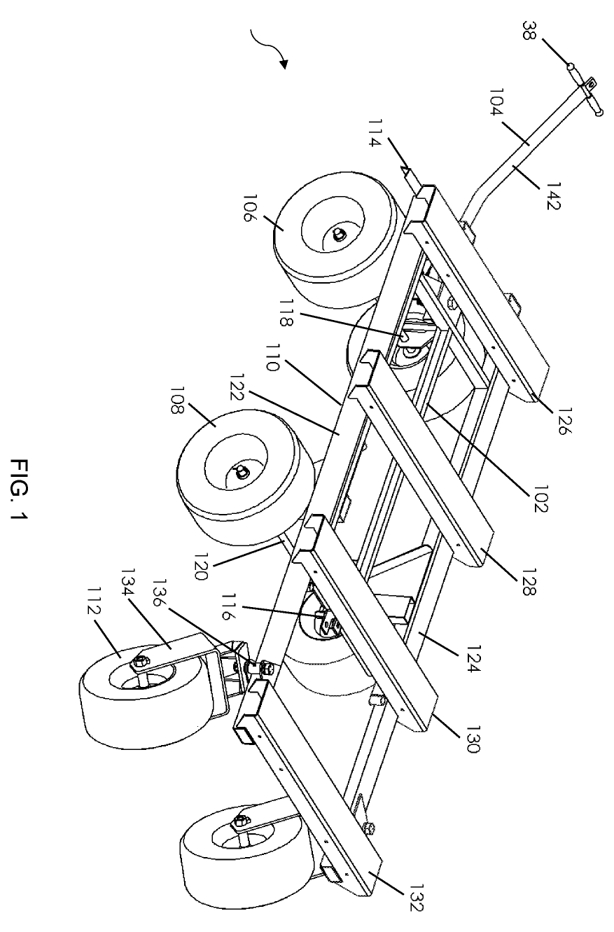

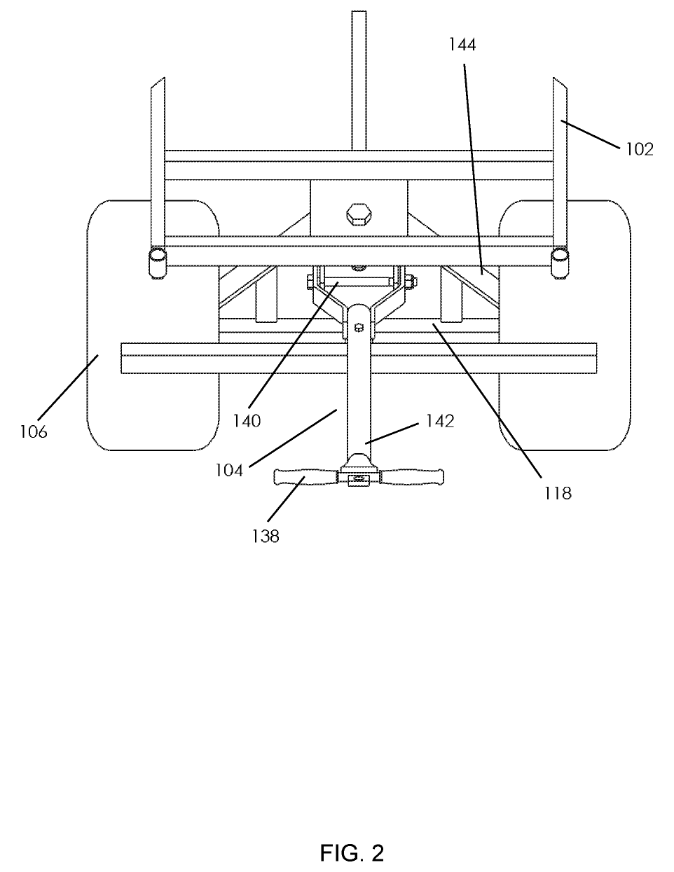

FIGS. 1-2 depict a trailer assembly 100. Trailer assembly 100 includes frame 102, steering assembly 104, first transport wheels 106, second transport wheels 108, trailer extension 110, and swivel wheels 112. Frame 102 includes frame leading end 114, frame trailing end 116, wheel axle 118, and wheel axle 120. Trailer extension 110 includes support rail 122, support rail 124, slat 126, slat 128, slat 130, and slat 132. Swivel wheels 112 include attachment mechanism 134 and rotatable pin 136. Steering assembly 104 includes steering handle 138 and steering assembly shaft 142.

Frame 102 is coupled to steering assembly 104 at frame leading end 114 via pin engagement mechanism 140 (depicted in FIG. 2). Frame 102 is movably supported by first transport wheels 106 and second transport wheels 108. First transport wheels 106 are coupled to frame 102 via wheel axle 118. Second transport wheels 108 are coupled to frame 102 via wheel axle 120. Trailer extension 110 is coupled to frame 102 via a connection between support rail 122 and frame 102 and a parallel connection between support rail 124 and frame 102. Support rail 122 and support rail 124 extend longitudinally from frame leading end 114 in a longitudinal direction toward frame trailing end 116. In some embodiments, the connection between trailer extension 110 and frame 102 is detachable and in other embodiments the connection between trailer extension 110 and frame 102 is fixed. In some embodiments, frame 102 and trailer extension 110 are integrated as one part.

Slat 126, slat 128, slat 130, and slat 132 span between support rail 122 and support rail 124. Slat 126, slat 128, slat 130, and slat 132 extend laterally across trailer extension 110 in a direction perpendicular to the longitudinal axis (i.e., the direction in which support rail 122 and support rail 124 extend). In some embodiments, slat 126, slat 128, slat 130, and slat 132 are coupled to support rail 122 and support rail 124. In other embodiments, slat 126, slat 128, slat 130, and slat 132 are additionally or alternatively coupled to frame 102.

As shown in FIG. 1, trailer assembly 100 has four slats (i.e., slat 126, slat 128, slat 130, and slat 132), but it is understood that any number of slats can be used within trailer assembly 100. In some embodiments, one slat, two slats, or three slats are used. In some embodiments, more than four slats are used. In the depicted embodiment, slat 126, slat 128, slat 130 and slat 132 are longitudinally spaced apart from the adjacent slat along the longitudinal length of support rail 122 and support rail 124. In embodiments where less than four slats or more than four slats are present, the slats can be placed such that each of the slats are longitudinally spaced apart from an adjacent slat along the length of support rail 122 and support rail 124.

Swivel wheels 112 are coupled to trailer extension 110 via attachment mechanism 134. In some embodiments, swivel wheels 112 are removably coupled to trailer extension 110, and can be removed via detachment of attachment mechanism 134 from trailer extension 110. In other embodiments, swivel wheels 112 are removable from frame 102 as a function of trailer extension 110 being detachable from frame 102. In still other embodiments, swivel wheels 112 are fixedly coupled to frame extension 110.

In various embodiments, a connection location of swivel wheels 112 can be varied. In the depicted embodiment, swivel wheels 112 are coupled to frame extension 110 via coupling a first swivel wheel of swivel wheels 112 to support rail 122 and coupling a second swivel wheel of swivel wheels 112 to support rail 124. In the depicted embodiments, swivel wheels 112 are coupled between slat 132 and slat 134. In other embodiments, swivel wheels 112 are coupled to support rails 122 and 124 at a different location. For example, support rail 122 and support rail 124 can extend beyond slat 134, and swivel wheels 112 can be coupled to support rail 122 and support rail 124 at a location between slat 134 and a distal end of trailer extension 110. In other embodiments, swivel wheels 112 can be coupled to frame extension 110 via coupling to a slat. Thus, swivel wheels 112 can be coupled to, for example, slat 132 or slat 134.

In operation, trailer assembly 100 allows for materials to be placed on a top surface of trailer extension 110, and therefore on slat 128, slat 130, slat 132, and slat 134. In some embodiments, the carrying capacity of trailer assembly 100 is at least 2,000 lbs. In other embodiments, the carrying capacity of trailer assembly 100 is at least 3,000 lbs. In some embodiments, wherein frame extension 110 is removably attached to frame 102, the carrying capacity of frame 102 alone is at least 2,000 lbs., and the carrying capacity of frame extension 110 (including slat 128, slat 130, slat 132, and slat 134) in combination with frame 102 is at least 3,000 lbs.

After materials are placed on the top surface of trailer extension 110, such materials can be hauled by operations of steering assembly 104. During hauling, steering assembly 104 can be used by an operator to push, pull, or otherwise translate trailer assembly 100 in a desired direction. Steering assembly 104 can be used to rotate first transport wheels 106 about a rotation axis, the rotation axis being perpendicular to the longitudinal axis. Thus, trailer assembly 100 is not restricted to linear movement, but can turn via the rotation of first transport wheels 106. A more detailed description of the steering mechanism of steering assembly 104 is provided below in the description of FIG. 2.

In addition to steering assembly 104 being used to turn trailer assembly 100, swivel wheels 112 can also be used to turn trailer assembly 100. Swivel wheels 112 allow for a tighter turn radius, as compared to first transport wheels 106, as swivel wheels 112 are freely rotatable about a swivel axis perpendicular to the longitudinal axis. Swivel wheels 112 are rotatable via operation of rotatable pin 136. Thus, as rotation is required, rotatable pin 136 rotates attachment mechanism 134, and hence rotates swivel wheels 112. Thus, trailer assembly 100 is turnable both by operation of first transport wheels 106 and swivel wheels 112.

FIG. 2 is a perspective view of steering assembly 104 of trailer assembly 100. FIG. 2 also includes a depiction of frame 102 and first transport wheels 106. Steering assembly 104 includes steering handle 138, pin engagement mechanism 140, and steering assembly shaft 142. Frame 102 includes wheel axle 118 and frame axle bar 144.

Within steering assembly 104, steering handle 138 is located on a distal end (i.e., the end furthest from frame 102) of steering assembly. Steering handle 138 is integrally coupled with steering assembly shaft 142. Steering assembly shaft is coupled to frame 102 via pin engagement mechanism 140. Within frame 102, axle 118 is coupled to a body of frame 102 via frame axle bar 144. First transport wheels 106 are coupled to frame 102 via mounting of first transport wheels 106 to axle 118.

In operation, steering assembly 104 is used to push or pull first transport wheels 106, thereby allowing trailer assembly to make turns. In order to turn, steering assembly 104 is pivoted about the rotation axis via steering handle 138. As a result, frame axle bar 144 is also rotated due to the connection between steering assembly 104 and frame axle bar 144 via pin engagement mechanism 140. Frame axle bar 144 is integrally connected to axle 118 and hence axle 118 is rotated. Correspondingly, first transport wheels 106 rotated about the rotational axis.

The configuration of trailer assembly 100 provides various advantages. Trailer assembly 100 allows for an increased load to be supported on a top surface of trailer extension 110, as slat 128, slat 130, slat 132, and slat 134 increase the carrying capacity. In some embodiments, the carrying capacity can be increased from at least 2,000 lbs. to at least 3,000 lbs. by adding trailer extension 110 to frame 102. Swivel wheels 112 provide the additional advantage of enhancing the turn radius of trailer assembly 100. While trailer assembly is turnable by operation of steering assembly 104 rotating first transport wheels 106, swivel wheels 112 provide a tighter turn radius as compared to first transport wheels 106, thereby improving the maneuverability of trailer assembly 100. The steering assembly 104 allows for maneuverability of trailer assembly 100 by using steering handle 138. Further, swivel wheels 112 allow for more maneuverability and a tighter turn radius when operating trailer assembly 100. Additionally, trailer extension 110 can be removably attached to frame 102, and when removed, frame 102 can remain operational as a trailer for transporting material while still being rotatable via operation of steering assembly 104. Alternatively, trailer extension 110 can be integrated as a single component with frame 102, and both steering assembly 104 and swivel wheels 112 can be available for rotation of trailer assembly 100.

The techniques of this disclosure are directed to a trailer for transporting materials. In the described embodiments, the combination or single component integration of the frame and trailer extension allow for increased loads to be placed on the trailer (e.g., from at least 2,000 lbs. to at least 3,000 lbs.). Further, the addition of the swivel wheels allow for the increased maneuverability of the trailer in addition to the rotation allowed by the steering assembly. Thus, the improved trailer has an enhanced carrying capacity and enhanced maneuverability.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the "a" or "an" are employed to describe elements and components of the embodiments herein. This is done merely for convenience and to give a general sense of the description. This description should be read to include one or at least one and the singular also includes the plural unless it is obvious that it is meant otherwise.

Furthermore, the figures depict preferred embodiments for purposes of illustration only. One skilled in the art will readily recognize from the discussion herein that alternative embodiments of the structures and methods illustrated herein may be employed without departing from the principles described herein.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

CLAIMS:

1. A trailer extension for a trailer frame, the trailer extension comprising:
a trailer extension body having a first end and a second end comprising:
a first support rail extending longitudinally from the first end to the second end, the first support rail attachable to the trailer frame;
a second support rail extending longitudinally from the first end to the second end, the second support rail attachable to the trailer frame, wherein the second support rail is parallel to the first support rail; and
at least a first slat secured to the first support rail and the second support rail, the first slat spanning between the first support rail and the second support rail; and
a pair of swivel wheels comprising a first swivel wheel and a second swivel wheel, the pair of swivel wheels mounted on the trailer extension body, and the pair of swivel wheels freely rotatable about a first axis.

2. The trailer extension of claim 1, wherein the first swivel wheel is removably attached to the first support rail and the second swivel wheel is removably attached to the second support rail.

3. The trailer extension of claim 1, wherein the pair of swivel wheels are removably attached to the first slat.

4. The trailer extension of claim 1, further comprising a second slat, a third slat, and a fourth slat, each of the second slat, the third slat, and the fourth slat spanning between the first support rail and the second support rail, and wherein each of the first slat, the second slat, the third slat and the fourth slat are longitudinally spaced apart from an adjacent slat between the first end and the second end.

5. The trailer extension of claim 4, wherein the pair of swivel wheels are removably attached to the trailer extension body between the third slat and the fourth slat.

6. The trailer extension of claim 4, wherein the pair of swivel wheels are removably attached to the trailer extension body between the fourth slat and the second end of the trailer extension body.

7. A trailer comprising:
a frame including a leading end and a trailing end spaced from the leading end along a longitudinal axis, the frame comprising:
a frame body comprising one or more frame members for supporting a load and one or more wheel axles;
a first rail extending longitudinally from the leading end to the trailing end, the first rail coupled to the frame body;
a second rail laterally spaced from the first rail, the second rail extending longitudinally from the leading end to the trailing end and the second rail coupled to the frame body;
a steering assembly extending from the leading end and pivotable about at least one steering axis perpendicular to the longitudinal axis;
a first pair of transport wheels located on opposite sides of the frame and connected to one of the one or more wheel axles of the frame body, the first set of transport wheels steerable via the steering assembly and the first pair of transport wheels movably supporting the frame; and
a pair of swivel wheels located on opposite sides of the frame, the pair of swivel wheels freely rotatable about a swivel axis perpendicular to the longitudinal axis of the frame.

8. The trailer of claim 7, further comprising a second pair of transport wheels located on opposite sides of the frame and connected to one of the one or more wheel axles of the frame body, the second pair of transport wheel movably supporting the frame.

9. The trailer of claim 7, further comprising a plurality of slats coupled to the frame, the plurality of slats extending laterally across the frame in a direction perpendicular to the longitudinal axis.

10. The trailer of claim 9, wherein each of the plurality of slats are coupled to the first rail at a first lateral end and the second rail at a second lateral end.

11. The trailer of claim 9, wherein the plurality of slats comprise a first slat, a second slat, a third slat, and a fourth slat, and wherein each of the first slat, second slat, third slat and fourth slat are longitudinally spaced apart from an adjacent slat between the leading end and the trailing end.

12. The trailer of claim 9, wherein a carrying capacity of the frame in combination with the first slat, the second slat, the third slat, and the fourth slat is at least 2000 pounds.

13. The trailer of claim 9, wherein a carrying capacity of the frame in combination with the first slat, the second slat, the third slat, and the fourth slat is at least 3000 pounds.

14. The trailer of claim 7, wherein the steering assembly comprises:
a steering handle located on a distal end of the steering assembly;
a pin engagement mechanism on a proximal end of the steering assembly, the pin engagement mechanism pivotably coupling the steering assembly to the frame; and
a shaft extending between the steering handle and the pin engagement mechanism.

15. A trailer, comprising:
a frame having a frame leading end and a frame trailing end spaced from the frame leading end along a longitudinal axis;
a steering assembly adjacent to the frame leading end and pivotable about at least one steering axis perpendicular to the longitudinal axis;
a first pair of transport wheels located on opposite lateral sides of the frame, the first set of transport wheels pivotable, via the steering assembly, about the steering axis, and the first pair of transport wheels movably supporting the frame;
a trailer extension mounted on a top side of the frame, the trailer extension having a trailer extension leading end and a trailer extension trailing end spaced from the trailer extension leading end along the longitudinal axis; and
a pair of swivel wheels located on opposite lateral sides of the trailer extension proximate the trailer extension trailing end, the pair of swivel wheels freely rotatable about a swivel axis perpendicular to the longitudinal axis.

16. The trailer of claim 15, further comprising a second pair of transport wheels located on opposite sides of the frame the second pair of transport wheel movably supporting the frame.

17. The trailer of claim 15, wherein the trailer extension is removably coupled to the frame.

18. The trailer of claim 15, wherein the trailer extension is fixedly coupled to the frame.

19. The trailer of claim 15, wherein the trailer extension comprises:
a first rail extending longitudinally from the trailer extension leading end to the trailer extension trailing end
a second rail extending longitudinally from the trailer extension leading end to the trailer extension trailing end, wherein the second rail is laterally spaced apart from the first rail; and
one or more slats spanning from the first rail to the second rail.

20. The trailer of claim 19, wherein the swivel wheels are removably coupled to the first rail and the second rail.
